(19) United States
(12) Patent Application Publication
(10) Pub. No.: US 2007/0142035 A1
(43) Pub. Date: Jun. 21, 2007

(54) Method for recognizing name card by mobile phone having camera

(75) Inventor: Young Tae Lee, Seoul (KR)

Correspondence Address: LERNER GREENBERG STEMER LLP, P O BOX 2480, HOLLYWOOD, FL, 33022-2480, US

(73) Assignee: INZISOFT CO. LTD., GANGNAM-GU (KR)

(21) Appl. No.: 10/510,806

(22) PCT Filed: Sep. 17, 2004
(86) PCT No.: PCT/KR04/02192

§ 371 Date: Feb. 5, 2007

(51) Int. Cl. H04Q 7/38; H04Q 7/22; H04M 3/42

(52) U.S. Cl. 455/414.1

(57) ABSTRACT

The present invention relates to a method for recognizing a name card by a mobile phone having a camera. There is a lot of inconveniences to manually input contents into a name card in a conventional art. The present invention discloses a method for recognizing the contents of a name card using a camera attached to a mobile phone.

### TECHNICAL FIELD

The present invention relates to a method for recognizing a name card by a mobile phone having a camera. There is a lot of inconveniences to manually input contents into a name card in a conventional art. The present invention disclose a method for recognizing the contents of a name card using a camera attached to a mobile phone. The present invention is as follows five steps: (a) if a user takes a photograph of a name card by using the camera of the mobile phone, then it put the image of the name card into the mobile phone. (b) it makes a block data field such as name of the company, name, telephone number, mobile phone number, e-mail address of the name card. (c) it display a menu on the screen of the mobile phone the blocked data field for recognizing. (d) the user select a data from blocked data field, then select the menu of the selected data by using a cursor. Now, it recognizes characters of the selected data based on the selected menu. (e) the user can store fast and exactly these recognized characters of the name card into the mobile phone having a camera for future use.

### Background Art

There was a whole bunch of a name card in business and around us. People needed to manage this name card in professional. In an old method of management of a name card by mobile phone, you must type a name, name of the company, address, telephone number, and e-mail address. The present invention invented to solve the troublesomeness to input information of the name card by hand into a mobile phone.

The present invention invented to relate to a method for recognizing a name card by a mobile phone having a camera. Specially, the present invention invented to store as needed information of a name card by using a mobile phone camera.

By the using mobile phone camera, character recognition was the ability to identify machine printed characters in an automated or a semi-automated manner. A user did not have to type the information of the name card by hand using keyboard due to using the character recognition system.

The character recognition unit consisted of photoelectric conversion unit, character recognition management unit, memory unit, and output unit. The photoelectric conversion unit converted characters recognition by voltage waveform. Then the character recognition management unit converted from two-dimensional font character to one-dimensional font character of time series by scan as method of TV. Memory unit stored the special data of characters recognition from the scan with operation control program. The character recognition management unit managed to input through photoelectric conversion unit of the memory control program system. Now, it was compare with its standard pattern in the same memory character recognition unit. The prior characters was recognized first to identify machine printed characters in an automated or a semi-automated manner. The output unit transmitted recognized character not only computer but also other management information unit.

Text recognition, there were OCR(Optical Character Reader) to be able to recognize both off-line character and machine printed character, tablet to be able to recognize off-line character, OMR(Optical Mark Reader) to be able to recognize special character, Optical bar-code Reader, and MICR(Magnetic Ink Character Reader).

### DISCLOSURE OF INVENTION

Technical Problem

A method for recognizing a name card by a mobile phone having a camera with character recognition were being developed recently. In reference, they mentioned to store name, address, and telephone number and so on from a taken photograph of a name card by using a mobile phone having a camera at Korea official patent publication(2003-0063249) and Korea patented utility mother publication (20-0318689).

However, according to Korea official patent publication(2003-0063249) and Korea patented utility mother publication (20-0318689), they did not describe a specific method how to input a name, address, and telephone number and so on. They just described to input the name, address, and telephone number by using a mobile phone having a camera.

Technical Solution

The present invention provides a method of character recognition in fast and accuracy, how to recognize the characters of the name card after taken a photograph of a name card by a mobile phone having a camera.

Advantageous Effects

As mentioned above, in an old method of management of a name card by mobile phone (101), you must type a name, name of the company, address, telephone number, and e-mail address by hand. The present invention provides to store classified data fields such as name, name of the company, address, telephone number, and e-mail address in memory unit (271) after taken a photograph of a name card by using a mobile phone (101) having a camera (111). Thus, the present invention is not only easy and convenient to input the information such as name, name of the company, address, telephone number, and e-mail address, but also it can reduce time-consumer to handle those information of the name card. Also, it improves a time of recognition to ability to identify the characters in an automated or a semi-automated manner and by recognition of selected field.

### BRIEF DESCRIPTION OF THE DRAWINGS

The present invention will become better understand with reference to accompanying drawings which are given only by way of illustration and thus are not limitative of the present invention, wherein;

FIG. 1 is a view illustrating a camera attached to a mobile phone for applying of the present invention.

FIG. 2 is a block diagram in outline of mobile phone of FIG. 1 according to the present invention.

FIG. 3 is a flow chart of the method how to recognize a name card in the mobile phone according to the present invention.

FIG. 4 is a showing the display blocked field selection and menu for classifying the fields on the LCD screen according to the present invention.

### BEST MODE FOR CARRYING OUT THE INVENTION

For the above technical solution, the present invention is as follows five steps to recognize the characters: (a) If a user takes a photograph of a name card by using the camera of the mobile phone, then it put the image of the name card into the mobile phone having a camera. (b) It makes a block data field such as a name of the company, name, telephone number, mobile phone number, e-mail address of the name card. (c) It display a menu on the screen of the mobile phone the blocked data field for recognizing. (d) The user select a data from blocked data field, then select the menu of the selected data by using a cursor. Now, it recognizes characters of the selected data based on the selected menu. (e) The user can store fast and exactly these recognized characters of the name card into the mobile phone for future use.

Desirably, the menu from step (c) is including some parts of a name of the company, duty, name, home address, home telephone number, company telephone number, mobile phone number, facsimile number, e-mail address, URL (Uniform Resource Locator), department.

Desirably also, if Korean name or English name in a menu is selected, the character recognition recognizes the selected character fields by Korean recognition or English recognition, which is built in the mobile phone having a camera. If a user selects one of a name, a name of the company, or duty of a menu from a screen of a mobile phone having a camera, using Korean recognition recognizes the character. If a user selects one of a home telephone number, a company telephone number, a mobile phone number, or a facsimile number, using a numeric recognition recognizes the number, which is built in the mobile phone having a camera. If a user selects one of an e-mail address or URL, using English recognition recognizes an English character, which is built in the mobile phone having a camera. By a usage of input the information of a name card to a mobile phone, a user can handle very easy and fast with a usage.

Mode for the Invention

The present invention will become better understand with reference to accompanying drawings which are given only by way of illustration and thus are not limitative of the present invention. The reference codes of each Figure are indicator as same as the below code number.

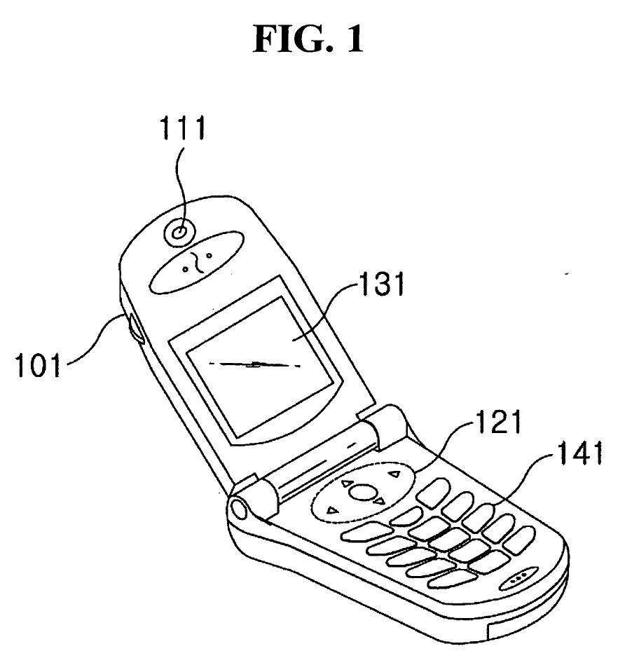

FIG. 1 is a view illustrating a camera (111 ) attached to a mobile phone (101) for applying of the present invention. As shown FIG. 1, a camera (111) attached to right above an LCD screen (131) using the product model recognition according to the present invention. A user can take a photograph of any objects by the camera (111). Also, a user can select items from the LCD screen (131) by using arrow key (121) above keyboard of the mobile phone (101).

A position of the camera (111) is possible to attach any part of the mobile phone (101) because it is up to how to design for manufacturing. In case of an attachable camera, the user can attach the camera when the user needs to take a photograph, otherwise in the pocket. Also, a user can attach close-up lens in the camera (111) to magnify so that a user can see the photograph enlarged. For instance, a user can take a photograph of characters such as name card enlarged with close-up lens.

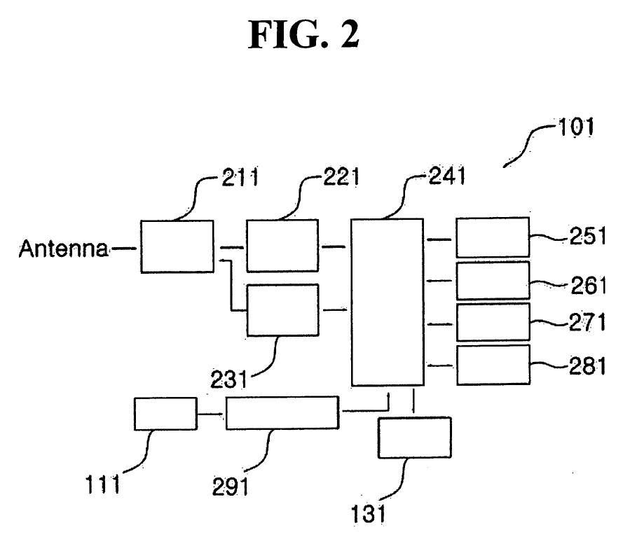

FIG. 2 is a block diagram in outline of mobile phone of FIG. 1 according to the present invention. As shown FIG. 2, a high frequency processing (211) of the mobile phone (101) is processing to receive through an antenna or processing a high frequency signal to transmit through an antenna. A/D conversion (221) is converting an analog to a digital to output from high frequency processing (211). D/A conversion (231) transmits high frequency signal converting a digital to an analog to output from controller (241). A power (251) is an electronic power supply to the mobile phone (101). Keyboard Input (261) transmits to controller (241) to generate a keyboard data for executing of dialing and setting. Memory (271) to store data, a character recognition unit (281) to be able to recognize a character of input data, a camera (111) to take a photograph, a video processing (291) to being a image processing of photograph, an LCD screen (131) to display the entire information, and a controller (241) to handle with operating of entire mobile phone processing.

The controller (241) includes CPU (Central Processing Unit) or Micro-controller, and Memory (271) includes Flash memory or EEPROM (Electrically Erasable Programmable Read Only Memory).

The character recognition (291) includes a Korean character recognition and English character recognition, also can be included any kind of foreign language recognition, which is Japanese, Chinese, Spanish, Russian, French, Germany, and so on.

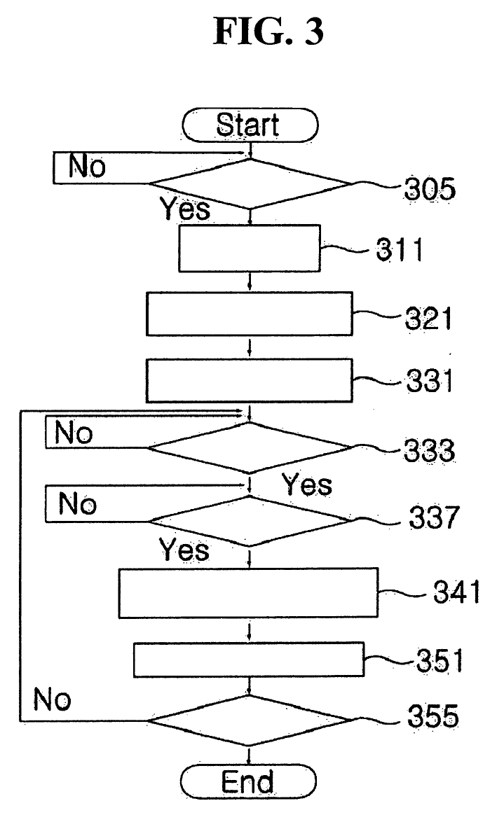

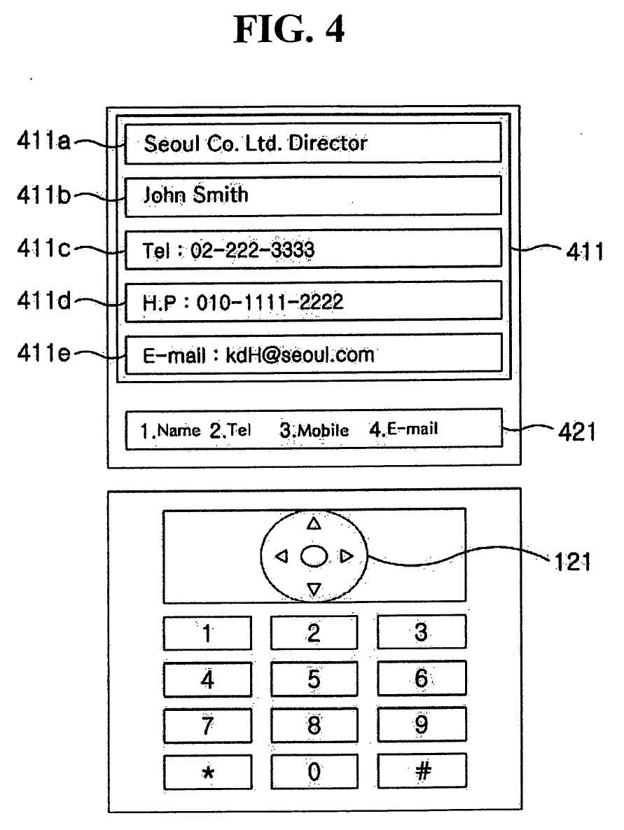

FIG. 3 is a flow chart of the method how to recognize a name card in the mobile phone (101) according to the present invention. FIG. 4 is a showing the display blocked field selection and menu for classifying the fields on the LCD screen (131) according to the present invention. As shown FIG. 3, the character recognition of a name card of the mobile phone (101) includes step 1 through step 6. Now, FIG. 1, FIG. 2, and FIG. 4 as a reference, to explain how it works to recognize the character of a name card from the mobile phone (101) of the illustration of FIG. 3, wherein;

In Step 1, if a user takes a photograph of a name card by using camera (111) of the mobile phone (101), the controller (241) will create the image (411) of the name card on the LCD screen (311).

In Step 2, the controller (241) is to be blocked (321) including the image (411) of the name card in fields. The fields (411a˜411e) include the name of the company, a duty, name, home address, home telephone number, company telephone number, mobile phone number, facsimile, e-mail address, URL (Uniform Resource Locator), department, and etc. Each field has a statement in a line. Thus, as shown FIG. 4, it is blocked the image (411) of a name card in a line. If there are two lines or more at a field, then a user can select two lines as a field. Also, if there are two fields or more at a line, then a user can divide two blocks in a line, divide two lines, or multiple selections.

In Step 3, the controller (241) display blocked fields (411a˜411e) and menu (421) for classifying the fields on the LCD screen (131) of the mobile phone (101). The menus (421) include the name of the company, a duty, name, home address, home telephone number, company telephone number, mobile phone number, facsimile, e-mail address, URL (Uniform Resource Locator), department, and etc. The designer of mobile phone (101) can display to choose the fields as need on the LCD screen (131), or can display the fields by a user's selection on the LCD screen (131).

In Step 4, a user selects (333) one of the blocked fields (411a˜411e) by using cursor of the LCD screen of the mobile phone (101). Then, if a user selects a menu (337) or a shortcut key based on the selected field to be matching in the menus (421), the controller (241) transmits to the character recognition (281). And then, the controller (241) can be recognized (341) the selected field based on selected menu by transmitting through the character recognition (281). For example, a user selects “John Smith” from the image of the name card (411), then select “1” from the menus (421), the controller (241) transmits “John Smith” to be matching with name to the character recognition (281). Now the character recognition (281) recognizes as the name (421-1) of “John Smith.”

If a user chooses “1” when the menus (421) recognize the selected fields, the controller (241) recognizes “John Smith” after transmitting to English character recognition of the character recognition (281). If a user chooses “2” or “3,” the controller (241) recognizes number after transmitting to numeric recognition of the character recognition (281). If a user chooses “4” when the menus (421) recognize the selected fields, the controller (241) recognizes the selected field after transmitting to Korean character recognition of the character recognition (281).

In the process of the recognizing field (411a), a mobile phone designer needs all kind of the responsibilities to store to the memory (271) before using. Thus, the controller (241) classifies clearly the selected fields compare with stored responsibilities of the memory (271) in the every recognition. The contents of the responsibilities in the memory (271) can upgrade when it is modified. At this point, it is in case of storing only a name of the company except the duty in the memory (271) when it is located in front of a name of the company.

It is needed clearly to recognize when its recognition of the telephone number, mobile phone number, facsimile, e-mail address, and etc. That is a telephone number, a facsimile, E-mail, for instance “Tel,” “Cell,” “Fax,” “E-mail,” and so on, these characters are not to be storing in the memory (271). For this, the unnecessary characters store in the memory (271) to be compared, but it is not to be stored in the field.

As mentioned above, a user selects the menu (421) based on the selected field, the fields (411a˜411e) is recognized the characters by the character recognition unit. Thus, the fields is recognized the fields (411a˜411e) clearly and fast.

At this point, the fields are to be able to the repetitive specification. For instance, if a telephone number and a facsimile number is in the same block, then a user can classify the block not only a telephone number but also a facsimile number. Also, although a user classify just one of the fields, the multiple selections will be possible in automatic. In case a user classify specified block as “name,” the recognition is automatically able to be the same effect as the repetitive specification of Korean name and English name. Also, when a user classifies only company telephone number, the multiple assignments will be possible automatically both facsimile and mobile phone number.

In Step 5, a controller (241) is stored a recognized field in a memory (271). At this time, the recognized fields are stored in the area of memory allocation (271) in the menu. This means that names are stored in a name memory allocation; telephone numbers are stored in a telephone number memory allocation; e-mail addresses are stored in an e-mail address memory allocation; facsimiles are stored in a facsimile memory allocation. As mentioned above, a display of the stored fields will be on the LCD screen (131) speedily.

In Step 6, if a user is done with selections of fields (355), then it will be end. Otherwise, repeat the step 4 though step 5 (355). If a user wants to terminate, click the “Complete” key by using arrow keys (121) of a keyboard of a mobile phone having a camera. If a “Complete” key is pressed, then a controller (241) will terminate a character recognition processing.

The present invention is not limited to the above embodiment. As the present invention may be embodied in several forms without departing from the spirit or essential characteristics thereof, it should also be understood that the above-described examples are not limited by any of the details of the foregoing description, unless otherwise specified, but rather should be constructed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. In a method for recognizing a name card by a mobile phone having a camera, comprising the steps of:
(a) a step in which an image of the name card taken photograph is inputted by the mobile phone having the camera;
(b) a step in which the image of the name card is blocked in fields;
(c) a step in which a menu for classifying the blocked fields and the fields is displayed on a screen of the mobile phone having the camera;
(d) a step in which a user select one of the fields using a cursor on the screen, and then select a menu or a shortcut key based on the selected field of the menu using a cursor, then a character in the selected fields based on the selected menu is recognized;
(e) a step in which a method for recognizing a name card by a mobile phone having a camera is including a storing of the recognized characters for future use.

2. The method of claim 1, wherein said the menu from step (c), a method for recognizing a name card by a mobile phone having a camera is including a part of a name of the company, duty, name, home address, home telephone number, company telephone number, mobile phone number, facsimile number, e-mail address, URL (Uniform Resource Locator), and department.

3. The method of claim 2, wherein said the menu from step (c), a method for recognizing a name card by a mobile phone having a camera is including a character recognition which is depend on a language, if Korean name or English name in the menu is selected, the character recognition recognizes the selected character fields by Korean recognition or English recognition, which is built in the mobile phone having a camera, if a name, a name of the company, or duty of the menu is selected, it is recognized characters of the selected fields by Korean recognition, which is built in the mobile phone having a camera; if a home telephone number, a company telephone number, a mobile phone number, or a facsimile number of the menu is selected, it is recognized numeric of the selected fields by a numeric recognition, which is built in the mobile phone having a camera; if an e-mail address or URL of the menu is selected, it is recognized character of the selected fields by English recognition, which is built in the mobile phone having a camera.

4. The method of claim 1, wherein in said step (b), a method for recognizing a name card by a mobile phone having a camera is including to be blocked the image of the name card by a line.

5. The method of claim 1, wherein in said step (a), a method for recognizing a name card by a mobile phone having a camera is including a close-up lens to be attached to the camera when a user take a photograph the image of the name card.
